(19) United States
(12) Patent Application Publication
(10) Pub. No.: US 2026/0325391 A1
(43) Pub. Date: Oct. 22, 2026

(54) WALKING AID AND STOWING METHOD FOR WALKING AID

(71) Applicant: Carebene Technology Co., Ltd., Shenzhen (CN)

(72) Inventors: Shangjin CHEN, Shenzhen (CN); Tong WANG, Shenzhen (CN); Yifan CHEN, Shenzhen (CN)

(21) Appl. No.: 19/707,250

(22) Filed: Jun. 13, 2026

Related U.S. Application Data
(63) Continuation of application No. PCT/CN2024/132568, filed on Nov. 18, 2024.

(30) Foreign Application Priority Data
May 24, 2024 (CN) 202410653260.2
May 24, 2024 (CN) 202421150442.X
May 24, 2024 (CN) 202421150447.2

(51) Int. Cl. A61H 3/04

(52) U.S. Cl. CPC A61H 3/04; A61H 2003/046

(57) ABSTRACT

A walking aid is provided. The walking aid comprises: a first frame main bar and a second frame main bar; a first bracket mounted at a first connection position on the first frame main bar, and a second bracket mounted at a second connection position on the second frame main bar; a third connection position on the first frame main bar, and the third connection position is lower than the first connection position; a fourth connection position on the second frame main bar, and the fourth connection position is lower than the second connection position; and a first support rod and a second support rod. The first frame main bar is connected to a first set of front and rear wheels through a first stowing assembly, and the second frame main bar is connected to a second set of front and rear wheels through a second stowing assembly.

### TECHNICAL FIELD

The present disclosure pertains to the technical field of walking aids, and specifically relates to a walking aid and a stowing method for a walking aid.

### BACKGROUND

A walking aid is an apparatus for assisting a human body in supporting weight, maintaining balance, and walking. Simply put, the walking aid reduces pressure on the legs, enabling individuals with limited mobility to travel freely. Existing walking aids can be used for seating as wheelchairs, and can also be used for walking assistance by pushing, providing new mobility assistance for elderly individuals.

Existing walking aids may occupy a large footprint. To facilitate carrying and storage, existing walking aids are designed to be foldable. However, the folding steps may be cumbersome and complicated, making the operation difficult for a user with limited mobility, and the stowed dimensions of the walking aid may still fail to achieve a compact and portable design.

### SUMMARY

In view of the above problems, an objective of the present disclosure is to provide a walking aid and a stowing method for a walking aid, and to enable the walking aid to be compact, lightweight, and easy to carry.

The present disclosure thus includes, without limitation, the following example embodiments.

Some embodiments provide a walking aid, comprising: a first frame main bar and a second frame main bar; a first bracket mounted at a first connection position on the first frame main bar, and a second bracket mounted at a second connection position on the second frame main bar; a third connection position on the first frame main bar, wherein the third connection position is lower than the first connection position; a fourth connection position on the second frame main bar, wherein the fourth connection position is lower than the second connection position; a first support rod and a second support rod, wherein one end of the first support rod is connected to the first bracket, and the other end of the first support rod is connected to the fourth connection position, and wherein one end of the second support rod is connected to the second bracket, and the other end of the second support rod is connected to the third connection position, and wherein the first frame main bar is connected to a first set of front and rear wheels through a first stowing assembly, and wherein the second frame main bar is connected to a second set of front and rear wheels through a second stowing assembly.

In some embodiments, a third bracket is mounted on the first frame main bar at the third connection position, and wherein a fourth bracket is mounted on the second frame main bar at the fourth connection position.

In some embodiments, one end of the first support rod is connected to the first bracket, and the other end of the first support rod is connected to the fourth bracket at the fourth connection position, and wherein one end of the second support rod is connected to the second bracket, and the other end of the second support rod is connected to the third bracket at the third connection position.

In some embodiments, the third bracket is fixedly arranged at a bottom end of the first frame main bar, and wherein the fourth bracket is fixedly arranged at a bottom end of the second frame main bar.

In some embodiments, the third bracket is slidable vertically along the first frame main bar, and wherein the fourth bracket is slidable vertically along the second frame main bar.

In some embodiments, the first bracket is slidable vertically along the first frame main bar, and wherein the second bracket is slidable vertically along the second frame main bar.

In some embodiments, the first stowing assembly comprises a first front connecting rod, a first rear connecting rod, a first front rotating rod and a first rear rotating rod, and wherein the second stowing assembly comprises a second front connecting rod, a second rear connecting rod, a second front rotating rod and a second rear rotating rod.

In some embodiments, the first front rotating rod and the first rear rotating rod are configured to lift the first set of front and rear wheels upward during folding, wherein the first set of front and rear wheels is flush with or higher than a bottom end of the first frame main bar after the folding, and wherein the second front rotating rod and the second rear rotating rod are configured to lift the second set of front and rear wheels upward during folding, wherein the second set of front and rear wheels is flush with or higher than a bottom end of the second frame main bar after the folding.

In some embodiments, the first front connecting rod and the first front rotating rod are connected to a first front wheel of the first set of front and rear wheels, and wherein the second front connecting rod and the second front rotating rod are connected to a second front wheel of the second set of front and rear wheels.

In some embodiments, the first front wheel is provided with a first steering mechanism, wherein the first steering mechanism includes a first connecting portion and a second connecting portion, wherein the first front connecting rod is connected to the first connecting portion, and wherein the first front rotating rod is connected to the second connecting portion.

In some embodiments, the second front wheel is provided with a second steering mechanism, wherein the second steering mechanism includes a third connecting portion and a fourth connecting portion, wherein the second front connecting rod is connected to the third connecting portion, and wherein the second front rotating rod is connected to the fourth connecting portion.

In some embodiments, the first rear connecting rod and the first rear rotating rod are connected to a first rear wheel of the first set of front and rear wheels, and wherein the second rear connecting rod and the second rear rotating rod are connected to a second rear wheel of the second set of front and rear wheels.

In some embodiments, a first auxiliary rod is provided at the third connection position, and a second auxiliary rod is provided at the fourth connection position, wherein one end of the first support rod is connected to the first bracket, and the other end of the first support rod is connected to the fourth connection position through the second auxiliary rod, and wherein one end of the second support rod is connected to the second bracket, and the other end of the second support rod is connected to the third connection position through the first auxiliary rod.

In some embodiments, the first frame main bar provides a first sliding groove and the second frame main bar provides a second sliding groove, and wherein the first auxiliary rod is configured to move within a range of the first sliding groove and the second auxiliary rod is configured to move within a range of the second sliding groove.

In some embodiments, a height of the first frame main bar and a height of the second frame main bar are less than 56 cm.

In some embodiments, a diameter of a first front wheel of the first set of front and rear wheels is smaller than a diameter of a first rear wheel of the first set of front and rear wheels, and wherein a diameter of a second front wheel of the second set of front and rear wheels is smaller than a diameter of a second rear wheel of the second set of front and rear wheels.

In some embodiments, a diameter of a first front wheel of the first set of front and rear wheels is equal to a diameter of a first rear wheel of the first set of front and rear wheels, and wherein a diameter of a second front wheel of the second set of front and rear wheels is equal to a diameter of a second rear wheel of the second set of front and rear wheels.

The present disclosure may provide the following beneficial effects: When the walking aid needs to be folded and stowed, one set of front and rear wheels on two sides of each frame main bar can be lifted by the stowing assembly, and move closer to the frame main bars, so that the walking aid has smaller stowed dimensions and is lightweight and convenient to carry and store. Moreover, the walking aid can be stowed by one-key operation, thereby improving the linkage and operational simplicity of folding and stowing the walking aid.

### BRIEF DESCRIPTION OF DRAWINGS

To describe the technical solutions in the embodiments of the present disclosure more clearly, the following briefly describes the accompanying drawings required in the embodiments. Clearly, the accompanying drawings in the following description show merely some embodiments of the present disclosure, and a person of ordinary skill in the art may still derive other accompanying drawings from these accompanying drawings without creative efforts.

FIG. 1 is a schematic structural diagram of a walking aid according to Embodiment 1 of the present disclosure;

FIG. 2 is a schematic structural diagram of the walking aid in an unfolded state according to Embodiment 1 of the present disclosure;

FIG. 3 is a schematic structural diagram of the walking aid during stowing according to Embodiment 1 of the present disclosure;

FIG. 4 is a schematic structural diagram of the walking aid in a stowed state according to Embodiment 1 of the present disclosure;

FIG. 5 is a schematic structural diagram of a frame main bar according to Embodiment 1 of the present disclosure;

FIG. 6 is a schematic structural diagram of a steering mechanism according to Embodiment 1 of the present disclosure;

FIG. 7 is a schematic structural diagram of a walking aid according to Embodiment 2 of the present disclosure;

FIG. 8 is a schematic structural diagram of the walking aid in a stowed state according to Embodiment 2 of the present disclosure;

FIG. 9 is a schematic structural diagram of a walking aid according to Embodiment 3 of the present disclosure; and

FIG. 10 is a schematic structural diagram of the walking aid during stowing according to Embodiment 3 of the present disclosure.

It should be noted that the accompanying diagrams are not necessarily drawn to scale, but are merely shown schematically in a way that does not affect reader's understanding.

The reference numerals in the description of embodiments are as follows:

100. Walking aid; 110. Frame main bar; 120. Handle; 130. First sliding bracket; 131. First mounting portion; 132. First mounting opening; 140. Second sliding bracket; 141. Second mounting portion; 142. Second mounting opening; 150. Front and rear wheels; 151. Front wheel; 152. Rear wheel; 153. Brake pad; 160. Main bar connecting assembly; 161. Support rod; 162. Intersection point; 170. Brake cable; 180. Steering mechanism; 181. First connecting portion; 182. Second connecting portion;

200. Stowing assembly; 210. Connecting rod group; 211. Front connecting rod; 212. Rear connecting rod; 220. Rotating rod group; 221. Front rotating rod; 222. Rear rotating rod; 223. Connecting rod; 224. Auxiliary rod; 225. Sliding groove.

### DESCRIPTION OF EMBODIMENTS

The following clearly and completely describes the technical solutions in embodiments of the present disclosure with reference to the accompanying drawings in embodiments of the present disclosure. Clearly, the described embodiments are merely some rather than all of embodiments of the present disclosure. All other embodiments obtained by a person of ordinary skill in the art based on the embodiments of the present disclosure without any creative effort shall fall within the protection scope of the present disclosure.

In the present disclosure, the orientation or positional relationships indicated by the terms such as "upper", "lower", "left", "right", "front", "rear", "top", "bottom", "inner", "outer", "middle", "vertical", "horizontal", "transverse", and "longitudinal" are based on the orientation or positional relationships shown in the accompanying drawings. These terms are mainly intended to better describe the present disclosure and embodiments thereof, and are not intended to limit that the indicated device, element, or component must have a particular orientation, or be constructed and operated in a particular orientation.

In addition, some of the foregoing terms may be used to express other meanings besides the orientation or positional relationships. For example, the term "upper" may also be used to express a certain attachment or connection relationship in some cases. For a person of ordinary skill in the art, the specific meanings of the terms in the present disclosure may be understood based on specific circumstances.

Furthermore, the terms "mounted", "arranged", "provided", "connect", and "connected" should be construed broadly. For example, the term may be a fixed connection, a detachable connection, or an integral connection; may be a mechanical connection or an electrical connection; and may be a direct connection, an indirect connection by using an intermediate medium, or internal communication between two devices, elements or components. A person of ordinary skill in the art may understand specific meanings of the foregoing terms in the present disclosure based on specific circumstances.

In addition, the terms such as "first" and "second" are mainly used to distinguish between different devices, elements or components (the specific types and structures may be the same or different), and are not used to indicate or imply the relative importance and quantity of the indicated devices, elements or components. Unless otherwise stated, "a plurality of" means two or more.

It should be further understood that the terms used in the specification of the present disclosure are for the purpose of describing specific embodiments only, and not for limiting the present disclosure. As used in this specification and the appended claims of the present disclosure, unless the context clearly indicates other cases, the singular forms "a", "one" and "this" are intended to include a plural form.

It should be further understood that the term "and/or" used in this specification and the appended claims of the present disclosure means any combination and all possible combinations of one or more of listed associated items, and these combinations are included.

Walking aids on the market occupy a large footprint. To facilitate carrying and storage, some existing walking aids are designed to be foldable. However, a seat cushion folding pull strap is usually connected to a seat cushion, and one end of the pull strap is connected to a switch. When the walking aid needs to be folded, the switch is triggered by pulling the seat cushion upward through the pull strap, so that the seat cushion is gradually folded in half, and frames on both sides move closer to each other as the seat cushion is folded in half. This method is only operable by ordinary individuals or a user with a caregiver present. For elderly individuals living alone who are already mobility-impaired, it requires bending the upper body down to the seat cushion before the walking aid can be stowed, making the operation difficult. Furthermore, the aforementioned method only allows for one-directional stowing of a walking aid, and stowed dimensions fail to meet the user's requirements for carrying and storage.

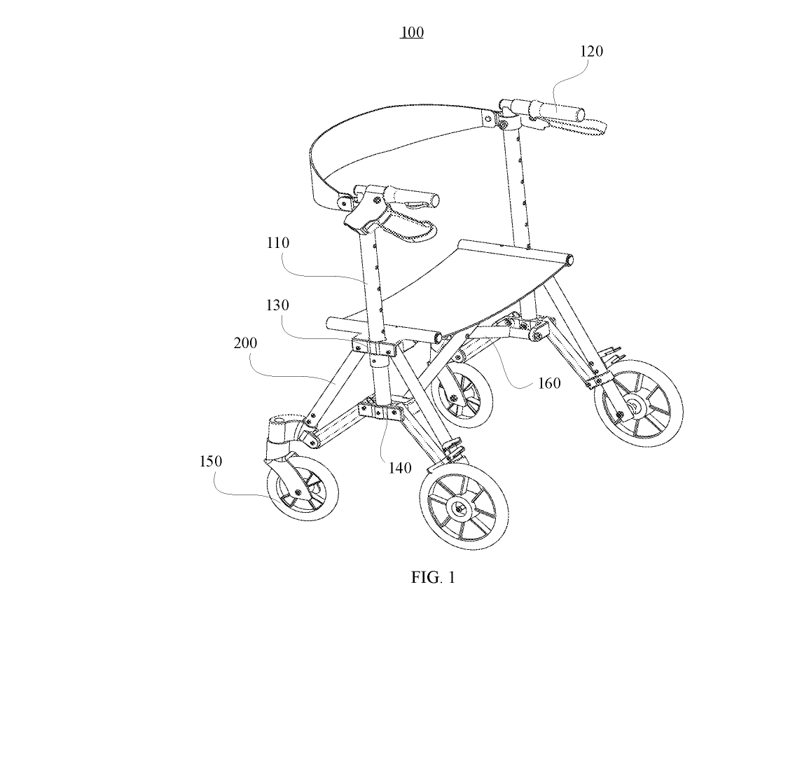

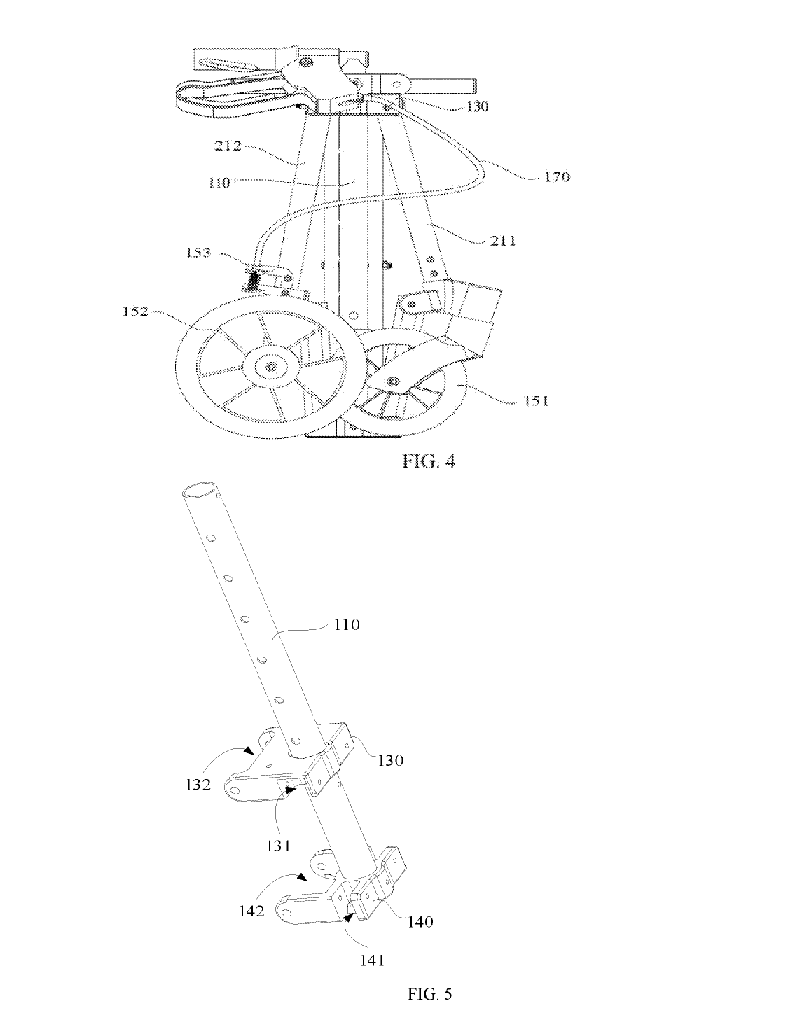

In view of the foregoing, embodiments of the present disclosure provide a stowing method for a walking aid and a walking aid. Referring to FIGS. 1 and 4, the walking aid 100 includes oppositely arranged frame main bars 110, two sets of front and rear wheels 150, two stowing assemblies 200, and a main bar connecting assembly 160 disposed between the two frame main bars 110.

During folding, first, the front and rear wheels 150 are lifted upward and folded close to the frame main bars 110 by the stowing assemblies 200; then the oppositely arranged frame main bars 110 move closer to each other and are folded by the main bar connecting assembly 160; and finally the front and rear wheels 150 are flush with or level with the frame main bars 110 or higher than bottom ends of the frame main bars 110, thereby completing the folding.

FIGS. 1-4 are schematic structural diagrams of a walking aid 100 according to an embodiment of the present disclosure. One set of front and rear wheels 150 is disposed on each of the frame main bars 110 oppositely arranged on both sides. Each frame main bar 110 is provided with a stowing assembly 200, and a main bar connecting assembly 160 is arranged between the two frame main bars 110. The stowing assembly 200 is configured to stow the wheels of the walking aid 100, so that in terms of stowed dimensions and stowing effects, the walking aid 100 is compact and easy to carry. The main bar connecting assembly 160 is configured to make the two oppositely arranged frame main bars 110 move closer to or away from each other.

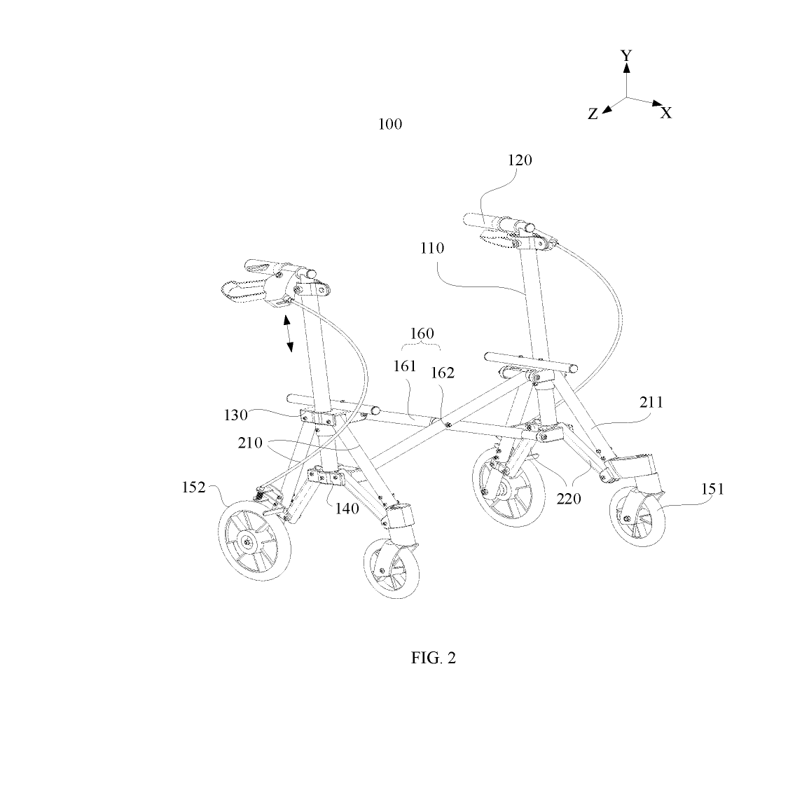

FIGS. 2-4 are schematic structural diagrams of the walking aid 100 in FIG. 1 with a seat cushion omitted. FIGS. 2, 3, and 4 illustrate the walking aid 100 in an unfolded state for use, a stowing state, and a stowed state respectively. As shown in FIGS. 2-4, when a user needs to stow the walking aid 100, since the stowing assemblies 200 are movable relative to the frame main bars 110, the stowing assemblies 200 lift and fold the front and rear wheels 150 to be within the length ranges of the frame main bars. In addition, the main bar connecting assembly 160 moves the two frame main bars 110 closer to each other until the folding is completed. This allows the walking aid 100 to be folded and stowed simultaneously in height Y, width X, and length Z directions, as shown by a three-axis coordinate system in FIG. 2.

Further, during folding, one end of each of the stowing assemblies slides along a corresponding frame main bar, to drive a corresponding set of front and rear wheels to rotate upward to move closer to the frame main bar.

One end of the stowing assembly 200 and one end of the main bar connecting assembly 160 are connected to the frame main bars 110 on both sides. During folding, one end of the stowing assembly 200 connected to the frame main bar 110 slides on the frame main bar 110, so that the two frame main bars 110 move closer to each other, and the front and rear wheels 150 located on both sides of each frame main bar 110 move closer to each other and are lifted.

Specifically, one end of the stowing assembly 200 and one end of the main bar connecting assembly 160 are typically locked and connected to the frame main bars 110 on both sides by a locking structure, with the purpose of maintaining the unfolded state when the walking aid 100 is unfolded; and in an unlocked state, a locking switch enables the stowing assembly 200 and the main bar connecting assembly 160 to move relative to the frame main bars 110.

Another aspect of the present disclosure further provides a walking aid 100, which is applied to the stowing method for a walking aid 100 according to some embodiments. Still referring to FIGS. 1-4, the walking aid 100 includes oppositely arranged frame main bars 110, two sets of front and rear wheels 150, two stowing assemblies 200, and a main bar connecting assembly 160 disposed between the two frame main bars 110. One end of each of the stowing assemblies 200 is pivotally connected to a first connection position of a corresponding frame main bar 110, and the other end thereof is pivotally connected to a second connection position of the frame main bar 110. The front and rear wheels 150 are connected to the stowing assemblies 200.

The number of the frame main bars 110 corresponds to that of the stowing assemblies 200. The stowing assemblies 200 are connected to the first connection positions and the second connection positions of the frame main bars 110, so that the stowing assemblies 200 can move relative to the frame main bars 110 during folding, and then the front and rear wheels 150 rotate upward.

In some embodiments of the present disclosure, the stowing assemblies 200 each include a connecting rod group 210 and a rotating rod group 220, one end of the connecting rod group 210 is connected to a corresponding set of front and rear wheels 150, and the other end thereof is pivotally connected to the first connection position of a corresponding frame main bar 110; one end of the rotating rod group 220 is connected to the set of front and rear wheels 150, and the other end thereof is pivotally connected to the second connection position of the frame main bar 110; and the first connection position is located above the second connection position.

The connecting rod group 210 is configured to enable the set of front and rear wheels 150 to move closer to each other toward the frame main bar 110 during folding, and the rotating rod group 220 is configured to enable the set of front and rear wheels 150 to rotate upward during folding, until the set of front and rear wheels is flush with a bottom end of the frame main bar 110 or higher than the frame main bar 110. Therefore, the connecting rod group 210 is connected to the first connection position of the frame main bar 110, and the first connection position is higher than the second connection position connecting the rotating rod group 220 and the frame main bar 110.

Specifically, the walking aid 100 further includes a first sliding bracket 130 mounted at the first connection position and a second sliding bracket 140 mounted at the second connection position. One end of the connecting rod group 210 is connected to the frame main bar 110 by the first sliding bracket 130; and one end of the rotating rod group 220 is connected to the frame main bar 110 by the second sliding bracket 140.

In some embodiments of the present disclosure, as shown in FIGS. 2-4, the first sliding bracket 130 and the second sliding bracket 140 are sleeved on the frame main bar 110. The first sliding bracket 130 corresponds to the aforementioned first connection position of the frame main bar, and the second sliding bracket 140 corresponds to the aforementioned second connection position. There are many ways to movably connect the stowing assembly 200 to the frame main bar 110, as long as the connecting rod group 210 and the rotating rod group 220 are connected to two points on the frame main bar 110 respectively. This is not limited herein.

In some embodiments of the present disclosure, the first sliding bracket 130 and the second sliding bracket 140 are sleeved on the frame main bar 110, and the first sliding bracket 130 is slidable on the frame main bar 110, to move closer to or away from the second sliding bracket 140. The second sliding bracket 140 is fixedly arranged at the bottom end of the frame main bar 110.

In some embodiments, the rotating rod group 220 and the connecting rod group 210 enable the coordinated linkage of the stowing assembly 200 by causing the first sliding bracket 130 and the second sliding bracket 140 slidable on the frame main bar to move closer to or away from each other, thereby enabling the walking aid 100 to be stowed simultaneously in multiple directions.

During folding of the walking aid 100, the connecting rod group 210 and the rotating rod group 220 can be moved correspondingly in the following manners: the first sliding bracket 130 slides along the frame main bar 110 and the second sliding bracket 140 is fixedly connected to the frame main bar 110, or the second sliding bracket 140 slides along the frame main bar 110 and the first sliding bracket 130 is fixedly connected to the frame main bar 110, or the first sliding bracket 130 and the second sliding bracket 140 move closer to or away from each other on the frame main bar.

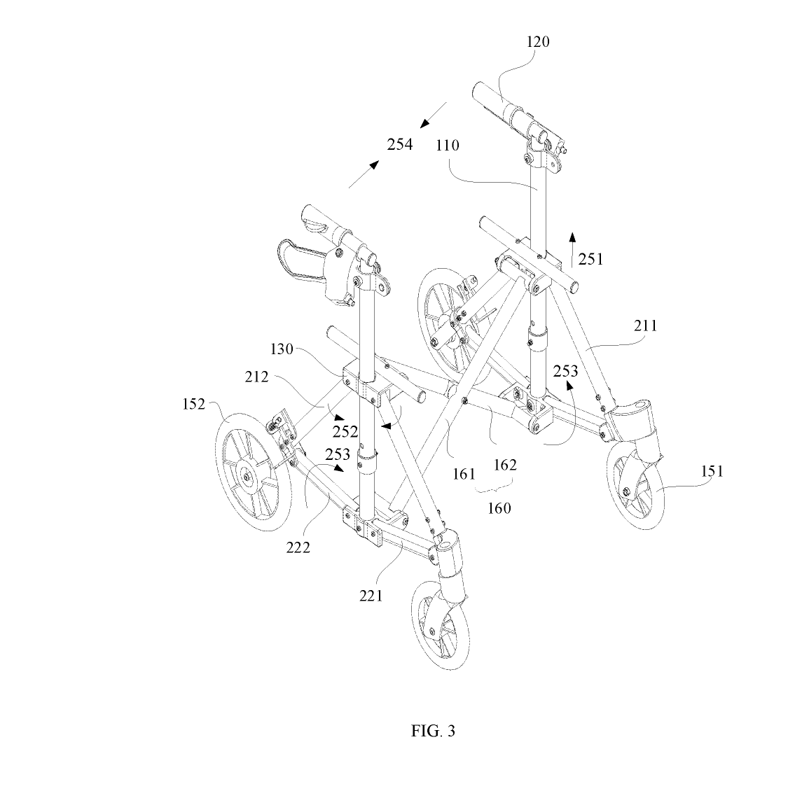

In Embodiment 1 of the present disclosure, referring to FIGS. 1 and 4, a first sliding bracket 130 is arranged on the frame main bar 110, and a second sliding bracket 140 is fixedly arranged at an end of the frame main bar 110, namely an end away from a handle 120. During folding, the first sliding bracket 130 slides upward in the direction indicated by the arrow 251 in FIG. 3. The connecting rod group 210 also moves upward as the first sliding bracket 130 slides upward, and moves closer to the frame main bar 110 in the direction indicated by the arrow 252 in FIG. 3. As the connecting rod group 210 moves upward, the rotating rod group 220 is folded upward in the direction of the arrow 253 in FIG. 3 and moves closer to the frame main bar 110, thereby driving the front and rear wheels 150 to lift upward.

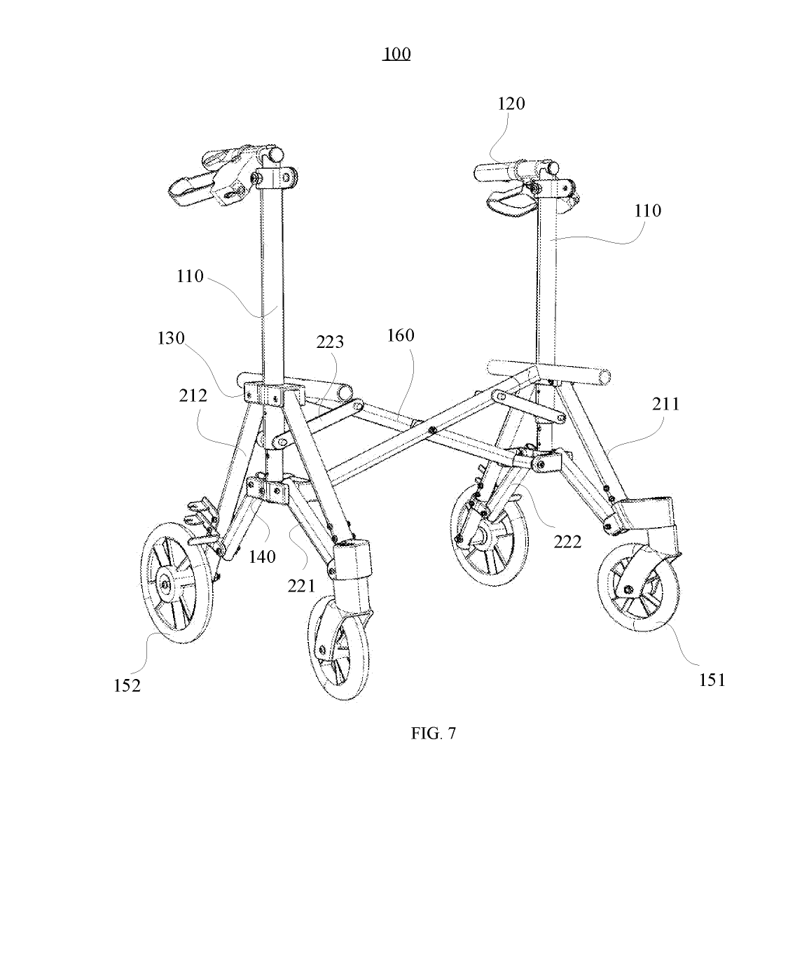

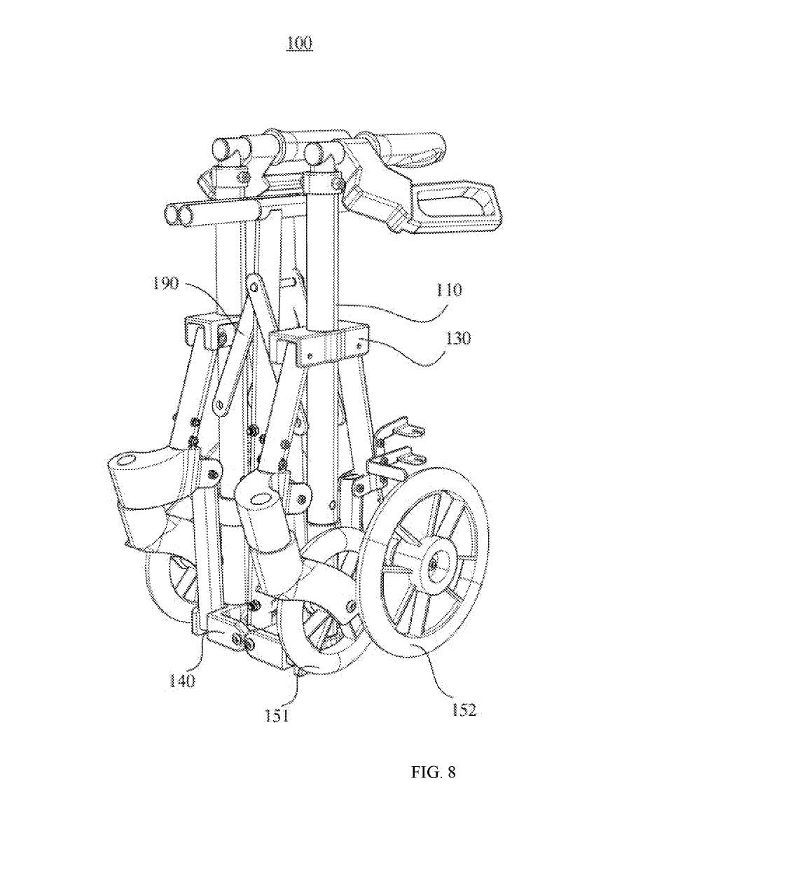

In Embodiment 2 of the present disclosure, referring to FIGS. 7 and 8, a main bar connecting assembly 160 is disposed between frame main bars 110 on both sides. The main bar connecting assembly 160 is connected to the frame main bars on both sides by connecting rods 223. When the walking aid 100 needs to be folded, by pressing down the frame main bar 110, the second sliding bracket 140 fixedly connected thereto is driven to move downward, so that the connecting rods 223 rotate from an inclined state to gradually become parallel with the frame main bar. Since a front rotating rod 221 and a rear rotating rod 222 are rotatably connected to the second sliding bracket 140, when the second sliding bracket 140 moves downward with the frame main bar, the front rotating rod 221 and the rear rotating rod 222 flip upward along the second sliding bracket 140 toward an end of the frame main bar away from the second sliding bracket 140. The front rotating rod 221 and the rear rotating rod 222 change from a V-shaped downward opening to a V-shaped upward opening, and together with a front connecting rod 211 and a rear connecting rod 212, form a rhombus. A final state after the wheels are folded is as shown in FIG. 4.

In Embodiment 2, the second sliding bracket 140 may alternatively be pivotally connected to the frame main bar 110 in the same manner as the first sliding bracket 130. That is, the second sliding bracket 140 and the first sliding bracket 130 move closer to each other in the same direction or move away from each other in opposite directions during stowing of the walking aid 100. In this case, the frame main bar 110 is a telescopic rod with an adjustable length. Considering a relationship between the sliding range of the second sliding bracket 140 on the frame main bar 110 and the maximum movable amount of each linkage assembly in the walking aid 100, under the condition of limiting the length dimension of the frame main bar 110, the frame main bar 110 is used as a telescopic rod to allow the second sliding bracket 140 a certain margin to slide on the frame main bar 110. The length of each frame main bar 110 and a distance between the two frame main bars 110 preliminarily define the dimensions of the walking aid 100 when the walking aid is unfolded or stowed. Therefore, to ensure that the stowed dimensions of the walking aid 100 can be adjusted from multiple directions, when the second sliding bracket 140 is configured as being pivotally connected to the frame main bar 110, the second sliding bracket 140 is located on the telescopic rod inside the frame main bar 110.

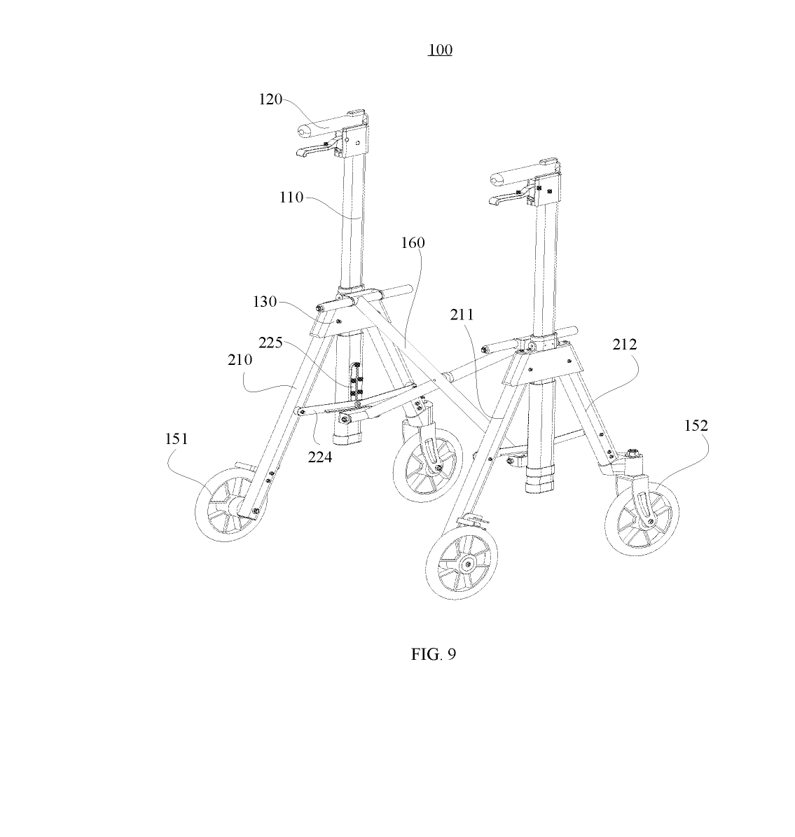

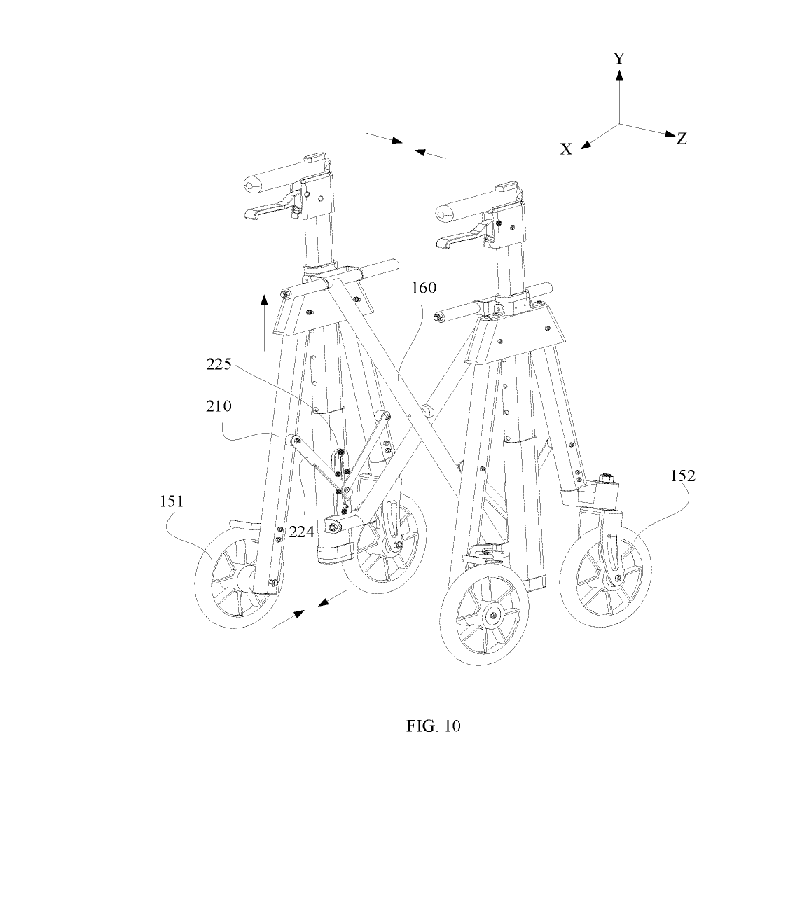

The present disclosure further provides Embodiment 3. Referring to FIGS. 9 and 10, in Embodiment 3 of the present disclosure, only one sliding bracket and a connecting rod group 210 are arranged on the frame main bar 110. The connecting rod group 210 is connected to a second connection position of the frame main bar 110 by an auxiliary rod 224. A surface of the frame main bar 110 that faces the main bar connecting assembly 160 is provided with a sliding groove 225, and the auxiliary rod 224 can move within the sliding groove 225. The main bar connecting assembly 160 and the stowing assembly 200 are connected to the sliding bracket. The connecting rod group 210 moves upward as the sliding bracket slides up, thereby driving a front wheel 151 and a rear wheel 152 connected thereto to move upward.

In Embodiment 3, no second sliding bracket 140 is provided, and the connecting rod group 210 is connected to the front wheel 151 and the rear wheel 152 of the walking aid 100. As a result, when the walking aid 100 is in an unfolded state, the walking aid 100 may become unstable and shake, or a user cannot stand steadily while stowing the walking aid 100 since the fixed connection between the stowing assembly 200 and the frame main bar 110 is released during stowing of the walking aid 100 and the user can no longer be supported. To prevent this situation, an auxiliary rod 224 is provided. The auxiliary rod 224 serves to provide auxiliary support when the walking aid 100 is unfolded, thereby further enhancing the structural stability. Since the front connecting rod 211 and the rear connecting rod 212 are connected to the auxiliary rod 224, and the auxiliary rod 224 can move within the sliding groove 225, during stowing of the walking aid 100, the front connecting rod 211 and the rear connecting rod 212 move upward as the sliding bracket slides upward, and the auxiliary rod 224 moves and folds within the range of the sliding groove 225, forming a V shape as shown in FIG. 8.

Still referring to FIGS. 1-4, in Embodiment 1 of the present disclosure, the connecting rod group 210 includes a front connecting rod 211 and a rear connecting rod 212, and the set of front and rear wheels 150 includes a front wheel 151 and a rear wheel 152. The front connecting rod 211 is connected to the first sliding bracket 130 and the front wheel 151, and the rear connecting rod 212 is connected to the first sliding bracket 130 and the rear wheel 152. The rotating rod group 220 includes a front rotating rod 221 and a rear rotating rod 222. The front rotating rod 221 is connected to the second sliding bracket 140 and the front wheel 151, and the rear rotating rod 222 is connected to the second sliding bracket 140 and the rear wheel 152. The front connecting rod 211 is connected to the front rotating rod 221, and the rear connecting rod 212 is connected to the rear rotating rod 222.

During folding of the walking aid 100, the first sliding bracket 130 slides in a direction away from the second sliding bracket 140, and as the first sliding bracket 130 slides upward, the front connecting rod 211 and the rear connecting rod 212 move upward, and move in the direction of the arrow 252 in FIG. 3, so as to drive the front wheel 151 and the rear wheel 152 on the same side to also move upward and closer to each other, thereby stowing the walking aid 100 in the X and Y directions in FIG. 2.

When the first sliding bracket 130 slides in a direction away from the second sliding bracket 140, the front rotating rod 221 and the rear rotating rod 222 rotate upward around the second sliding bracket 140 in the direction of the arrow 253 in FIG. 3. The front rotating rod 221 and the rear rotating rod 222 move closer to each other and move closer to the frame main bar 110, driving the front wheel 151 and the rear wheel 152 connected thereto respectively to also rotate upward in the Y direction from original positions below the frame main bar 110 into the height range of the frame main bar 110, thereby reducing the stowed dimensions of the walking aid 100 in the Y direction in FIG. 2. In addition, since the front rotating rod 221 and rear rotating rod 222 corresponding to the front wheel 151 and the rear wheel 152 move closer to each other, the front wheel and the rear wheel also move closer to each other, thereby reducing the stowed dimensions of the walking aid 100 in the X direction shown in FIG. 2.

In some embodiments, by the arrangement of the first sliding bracket 130 and the second sliding bracket 140 on the frame main bar 110, the front connecting rod 211 and the rear connecting rod 212 are connected to the first sliding bracket 130, the front rotating rod 221 and the rear rotating rod 222 are connected to the second sliding bracket 140, the front connecting rod 211 is connected to the front rotating rod 221, and the rear connecting rod 212 is connected to the rear rotating rod 222. Therefore, the front wheel 151 and the rear wheel 152 of the walking aid 100 can have dimensions adjusted in width and height, i.e., in the X and Y directions in FIG. 2, during stowing. In combination with the main bar connecting assembly 160 which adjusts the dimensions of the frame main bars 110 on both sides in the length direction, i.e., the Z direction in FIG. 2, the three-directional stowing of the walking aid 100 can be achieved only by pressing and pushing the handle 120, thereby achieving simple operation and high practicality. In terms of stowing effects and stowed dimensions, the walking aid is convenient to store and portable compared with the prior art.

It should be noted that "front wheel" and "rear wheel" as mentioned in the embodiments of the present disclosure are merely for better describing the wheels distributed on both sides of the walking aid, and for better describing the connection relationship between the aforementioned "front and rear wheels" and the stowing assemblies 200, and do not limit the positions and functions of the wheels.

In some embodiments, a distance between the front connecting rod 211 and the frame main bar 110 and a distance between the rear connecting rod 212 and the frame main bar 110 are equal; and a distance between the front rotating rod 221 and the frame main bar 110 and a distance between the rear rotating rod 222 and the frame main bar 110 are equal.

That is, the front connecting rod 211 and the rear connecting rod 212 are arranged symmetrically to each other; and the front rotating rod 221 and the rear rotating rod 222 are arranged symmetrically to each other. Because the front connecting rod 211 and the rear connecting rod 212 are arranged symmetrically to each other in a triangular shape on the frame main bar 110, and the front rotating rod 221 and the rear rotating rod 222 are also arranged symmetrically to each other in a triangular shape on the frame main bar 110, a plurality of triangles are formed among the frame main bar 110, the front connecting rod 211, the rear connecting rod 212, the front rotating rod 221, and the rear rotating rod 222. The plurality of triangular structures make the walking aid 100 more structurally stable when the walking aid is unfolded for use by the user. During movement of the walking aid 100, due to a plurality of three-point fixed supports, the mechanical structure of the walking aid 100 does not change during motion, allowing for precise control of the movement of the walking aid 100 and enhancing reliability of the walking aid 100.

More specifically, the main bar connecting assembly 160 includes two support rods 161 mounted in an intersecting manner. One end of each of the support rods 161 is pivotally connected to a corresponding second sliding bracket 140, and the other end thereof is pivotally connected to a corresponding first sliding bracket 130. The two support rods 161 rotate about an intersection point 162 and move closer to each other when the first sliding bracket 130 moves away from the second sliding bracket 140.

The main bar connecting assembly 160 is a linkage rod that connects the frame main bars 110 on both sides, and causes the frame main bars 110 on both sides to move closer to or away from each other in the direction of the arrow 254 in FIG. 3 as the first sliding bracket 130 slides upward. There are many ways to move the two opposite frame main bars 110 closer to each other to stow the walking aid 100. In some embodiments of the present disclosure, as shown in FIGS. 2-4, the main bar connecting assembly 160 includes two support rods 161 intersecting in an X shape. When the sliding bracket slides upward, the two support rods 161 rotate about an intersection point thereof and move closer to each other. Compared with structural designs of other shapes, the X-shaped structure requires fewer components, which can reduce the weight of the walking aid 100 while reducing manufacturing costs, and further meets the user's requirement for portability. In addition, the X-shaped structure is more stable during unfolding or stowing of the walking aid 100 compared with structural designs of other shapes. This achieves a better effect of multi-directional synchronous folding of the walking aid 100.

Certainly, the main bar connecting assembly 160 of the present disclosure may alternatively be in a W shaped, a V shape, a Y shape, an XX shape, or any other shape that can be formed by one or more sets of support rods having at least one intersection point. This is not limited herein.

In some embodiments of the present disclosure, each of the frame main bars 110 is provided with a handle 120 and a locking switch. When the handle 120 moves toward the frame main bar 110 to a maximum movable range, unlocking of the locking switch is triggered, and the main bar connecting assembly 160 is unlocked from the frame main bar 110, so that the frame main bars 110 on both sides move closer to or away from each other.

The locking switch is configured to allow the two frame main bars 110 to move closer to each other by the main bar connecting assembly 160 in an unlocked state. The locking switch is further configured to fix the stowing assemblies 200 and the main bar connecting assembly 160 to the frame main bars 110 in a locked state. In the present disclosure, the locking switch may be any locking buckle structure, such as a symmetrical lock buckle, a stepped lock buckle, a pin tumbler lock, a toggle switch, or another switch structure which when cooperating with an elastic member, enables the stowing assembly 200 to be firm and stable during use of the walking aid 100, and enables the stowing assembly 200 to be linked when the walking aid 100 needs to be stowed.

The stowing assembly 200 is a linkage assembly for unfolding or stowing the walking aid 100. The frame main bar 110 is provided with a handle 120, and a distance between the handle 120 and the frame main bar 110 can be adjusted, so as to adapt to users of different heights.

In an embodiment of the stowing method for a walking aid 100, after the user adjusts the handle 120 to a suitable height, the handle 120 is fixed on the frame main bar 110. As shown in FIGS. 2-4, during folding, when the user needs to stow the walking aid 100, a button (not shown) on the handle 120 is first pressed to unfix the handle 120 from the frame main bar 110, and then the handle 120 is pressed downward so that the handle 120 gradually moves closer to the frame main bar 110. When the handle 120 gradually moves closer to the frame main bar 110 and comes into contact with the locking switch, unlocking of the locking switch is triggered. In this case, the stowing assembly 200 can move relative to the frame main bar 110 and drive the frame main bars 110 on both sides to move closer to each other, so that the walking aid 100, as shown in three-dimensional coordinate axes in FIG. 2, is simultaneously folded and stowed in the height Y, width X, and length Z directions.

Specifically, the handle 120 may trigger the unlocking of the locking switch when retracting to a maximum retraction stroke toward the frame main bar 110, so as to unlock the stowing assembly 200 from the frame main bar 110, allowing the frame main bars 110 on both sides to move closer to or away from each other. In some embodiments of the present disclosure, the locking switch may alternatively be arranged on a retraction path of the handle 120, and the locking switch is triggered during the retraction of the handle 120. However, considering that when the handle 120 retracts to a maximum retractable position, a telescopic rod of the handle 120 completely enters the frame main bar 110. In this case, applying a pushing force to the handles 120 on both sides is equivalent to directly pushing the frame main bars 110 on both sides. This reduces the step of pressing the handles 120 again to stow the walking aid 100, and eliminates the need for the user to bend over deeply, making the operation more convenient and quicker.

In some embodiments of the present disclosure, the manner in which the switching of the walking aid from unfolding to folding is triggered, namely the manner in which the stowing assembly can be switched from a locked connection to the frame main bar to unlocking from the frame main bar, may alternatively be to pull a pull rod on the seat cushion or another manner.

In some embodiments of the present disclosure, as shown in FIG. 5, the first sliding bracket includes first mounting portions and a first mounting opening. The second sliding bracket includes second mounting portions and a second mounting opening. One end of the connecting rod group is coupled to the first mounting portions, and the rotating rod group is coupled to the second mounting portions. The main bar connecting assembly is coupled to the first mounting opening and the second mounting opening.

As shown in FIGS. 1-5, the first sliding bracket 130 is provided with first mounting portions 131 coupled to the front connecting rod 211 and the rear connecting rod 212, and a first mounting opening 132 coupled to the main bar connecting assembly 160. It should be noted that two oppositely arranged first mounting portions 131 are provided in FIG. 5, but one thereof is not shown due to the viewing angle. Correspondingly, the second sliding bracket 140 is provided with two second mounting portions 141 coupled to the front rotating rod 221 and the rear rotating rod 222 respectively, and a second mounting opening 142 coupled to the main bar connecting assembly 160. This enables the main bar connecting assembly 160, the front connecting rod 211, the rear connecting rod 212, the front rotating rod 221, and the rear rotating rod 222 to be linked with each other. The relative movement of the above components can be driven at a time by merely sliding the first sliding bracket 130 on the frame main bar 110, thereby enabling the walking aid 100 to be simultaneously folded or unfolded in the three axial directions X, Y, and Z in FIG. 2.

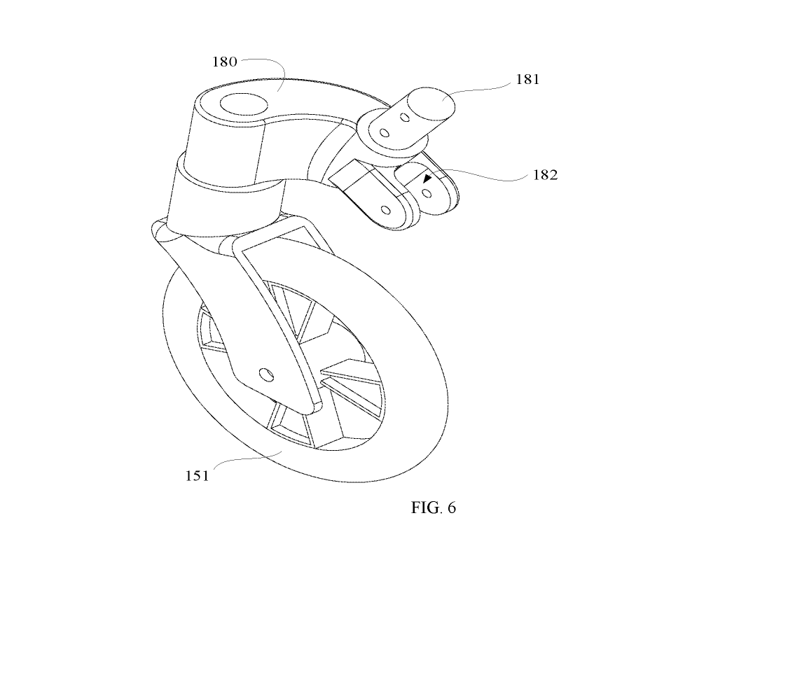

In some embodiments of the present disclosure, referring to FIGS. 1-4, and in conjunction with FIG. 6, the front wheel 151 is provided with a steering mechanism 180. The steering mechanism 180 includes a first connecting portion 181 and a second connecting portion 182. A front connecting rod 211 is connected to the first connecting portion 181, and a front rotating rod 221 is connected to the second connecting portion 182.

The front wheel 151 is provided with the steering mechanism 180. That is, the front wheel 151 is a universal wheel, to improve the flexibility and maneuverability of the walking aid 100, enabling the walking aid to adapt to various environments and allowing the walking aid to move more smoothly. Since the front connecting rod 211 needs to be pin-connected to the front rotating rod 221, and the front connecting rod 211 drives the front rotating rod 221 to rotate by a pin shaft when moving. Therefore, in some embodiments of the present disclosure, the steering mechanism 180 is further provided with a first connecting portion 181 and a second connecting portion 182 that are connected to the front connecting rod 211 and the front rotating rod 221 respectively, to achieve the pin connection between the front connecting rod 211 and the front rotating rod 221, thereby replacing the structure of a fixing pin or a positioning pin.

In some embodiments of the present disclosure, the walking aid 100 further includes a brake cable 170. One end of the brake cable 170 is connected to a brake pad 153 located on the rear wheel 152, and the other end thereof is connected to the handle 120.

As shown in FIGS. 1 and 2, the walking aid 100 further includes a handle 120, which is configured to be held by a user and functions to support a user with limited mobility in standing. The handle 120 can be telescopically adjusted in the direction of the frame main bar 110, i.e., in the Y-direction in FIG. 2, to adapt to users of various heights. Further, referring to FIGS. 2 and 3, when the walking aid 100 is folded to a final state, the handle 120 abuts against the first sliding bracket 130.

Still referring to FIGS. 2 and 4, the handle 120 is connected to the brake pad 153 by the brake cable 170, and a user can also control the braking of the walking aid 100 by the handle 120 to ensure user safety. Based on the above embodiment in which the front wheel is a universal wheel, because the load capacity of the universal wheel is weaker than an ordinary wheel due to a steering function, in some embodiments, the brake pad 153 is disposed on the rear wheel 152 to control the braking of the walking aid 100. The manner in which the handle 120 prevents wheel movement by the brake pad 153 may be any solution that achieves this function, and a structure such as the brake pad 153 may alternatively be disposed on any wheel of the walking aid 100.

The present disclosure further takes into account a situation in which a user needs to carry the walking aid on an aircraft. According to international airline baggage dimension regulations (here, referencing American Airlines), the maximum allowable dimensions of carry-on baggage for air travel are 56 cm × 36 cm × 23 cm. Here cm represents centimeters. When the walking aid is designed, it is necessary to consider not only the stowed dimensions of the walking aid to meet air travel carry-on regulations, but also the dimensions when the walking aid is unfolded, so that the walking aid can be used by most people.

In view of this, still referring to FIGS. 2-4, in some embodiments, the dimensions of the walking aid 100 unfolded for use and the stowed dimensions are designed. For ease of description and understanding, with reference to the coordinate axes in FIG. 2, in the following description, the height of the walking aid 100 is taken as the dimension in the Y-direction, the width as the dimension in the X-direction, and the length as the dimension in the Z-direction. To enable the walking aid 100 to comply with air travel carry-on dimensional regulations when the walking aid is stowed, the length × width × height of the walking aid 100 is less than or equal to 23 cm × 36 cm × 56 cm respectively.

First, regarding the height of the walking aid 100, to ensure that the height of the walking aid 100 does not exceed 56 cm, as shown in FIGS. 2-4, a total height of the frame main bar 110, the handle 120, and the wheels of the walking aid 100 needs to be less than 56 cm in a stowed state. Since the wheels are flush with the end of the frame main bar 110 when stowed to a final state, the height of the frame main bar 110 is designed to be less than 56 cm. The height of the handle 120 is adjusted by a telescopic rod, one end of the telescopic rod is located within the frame main bar 110, and the other end thereof protrudes from the frame main bar 110 in the height direction to be connected to the handle 120. Therefore, the sum of the height of the handle 120, the height of the telescopic rod protruding outside the frame main bar 110 after retraction, and the height of the frame main bar 110 are set as the overall stowed height of the walking aid 100, which is less than 56 cm.

Considering that the walking aid 100 further needs to provide a seat for a user to rest, when the stowed dimensions of the walking aid 100 need to be designed to meet air travel standards, the height of the seat cushion from the ground also needs to be considered. An excessively low seat cushion does not conform to ergonomic comfort requirements. In the present disclosure, the height of the seat cushion from the ground when the walking aid 100 is unfolded is 50 cm, and the diameter of a reserved seat cushion support tube is 2 cm. The stowage of the entire walking aid is primarily determined by a vertical angle of the frame main bars (including all directions), the diameter of the wheels, the positions of the wheels when unfolded or stowed, the main bar connecting assembly 160 connecting the left and right frame main bars 110, and the height of the seat cushion. As can be seen from the above, in the present disclosure, the first sliding bracket 130 slides to drive the movement of the main bar connecting assembly 160 to achieve stowing or unfolding. In addition, a sliding distance of the first sliding bracket 130 and the lengths of the X-shaped support rod 161 are designed. Since the sliding distance of the first sliding bracket 130 is associated with a rotation angle of the X-shaped support rod 161 of the main bar connecting assembly 160, and since the height of the frame main bar 110 needs to be less than 56 cm, the length of the X-shaped support rod 161 also needs to be less than the length of the frame main bar 110, i.e., 56 cm. Otherwise, the X-shaped support rod 161 would protrude beyond the frame main bar 110 after the stowing, leading to an overall height of the walking aid 100 greater than 56 cm. Considering the above issues, the length of the X-shaped support rod 161 is set to approximately 50 cm. The dimensions of the X-shaped support rod 161 after unfolding define the distance between the two oppositely arranged frame main bars 110, i.e., the length of the walking aid 100 during use, and the length of the walking aid 100 is designed to accommodate the range in which most users can sit on the seat cushion to rest, as shown in FIG. 1. According to survey data, the length of the walking aid 100 after unfolding is set to approximately 50 cm, and through this setting, the sliding distance of the first sliding bracket 130 on the frame main bar 110 is set. In addition, the length of the walking aid 100 may be set according to widths of aircraft aisles and cabin passages, so that the walking aid 100 can not only be carried for air travel but also used on the aircraft.

Secondly, regarding the width of the walking aid 100, it is essentially an adjustment of the distance between the front wheel 151 and the rear wheel 152. An example in which both the front wheel 151 and the rear wheel 152 have an outer diameter of 20 cm is used. Even if the front wheel 151 abuts against the rear wheel 152 when the walking aid 100 is stowed to a final state, the width of the walking aid 100 is 40 cm, which still exceeds the internationally stipulated dimension for carry-on compliant baggage. Therefore, as shown in FIG. 4, when the walking aid 100 of the present disclosure is stowed to a final state, the front wheel 151 and the rear wheel 152 are arranged in a staggered and overlapping manner, and the diameter of the front wheel 151 is set to be smaller than the diameter of the rear wheel 152. Specifically, the front wheel 151 has a diameter of 15 cm, and the rear wheel 152 has a diameter of 20 cm. In this way, when the walking aid 100 is stowed to a final state, the width of the walking aid 100 can meet air travel requirements, i.e., be less than 36 cm.

Regarding the length of the walking aid 100, the distance between the frame main bars 110 on both sides is adjusted, and most foldable walking aids 100 on the market can adjust this dimension to a carry-on compliant dimension, i.e., less than 23 cm. Details are not repeated herein. It should be noted that in terms of the dimension of the walking aid 100 in the length direction after the stowing, the impact of the staggered and overlapping arrangement of the front wheel 151 and the rear wheel 152 on the dimension of the walking aid 100 in the length direction needs to be considered.

The dimensions of the walking aid in some embodiments of the present disclosure that is stowed to a final state are 51 cm × 30.7 cm × 22.9 cm.

With respect to the embodiments of the present disclosure, it should be further noted the embodiments of the present disclosure and the features in the embodiments may be combined with each other without conflict to obtain new embodiments.

The foregoing are merely preferred embodiments of the present disclosure, and are not intended to limit the present disclosure in any form. The protection scope of the present disclosure shall be subject to the protection scope of the claims. Although the present disclosure has been disclosed as above with preferred embodiments, it is not intended to limit the present disclosure. Any person skilled in the art may make slight modifications or alterations to form equivalent embodiments with equivalent variations by using the technical content disclosed above without departing from the scope of the technical solution of the present disclosure. Any simple modifications, equivalent changes and alterations made to the above embodiments according to the technical essence of the present disclosure, which do not depart from the technical solution of the present disclosure, shall all fall within the protection scope of the present disclosure.

1. A walking aid, comprising:
a first frame main bar and a second frame main bar;
a first bracket mounted at a first connection position on the first frame main bar, and a second bracket mounted at a second connection position on the second frame main bar;
a third connection position on the first frame main bar, wherein the third connection position is lower than the first connection position;
a fourth connection position on the second frame main bar, wherein the fourth connection position is lower than the second connection position;
a first support rod and a second support rod, wherein one end of the first support rod is connected to the first bracket, and the other end of the first support rod is connected to the fourth connection position, and wherein one end of the second support rod is connected to the second bracket, and the other end of the second support rod is connected to the third connection position, and
wherein the first frame main bar is connected to a first set of front and rear wheels through a first stowing assembly, and wherein the second frame main bar is connected to a second set of front and rear wheels through a second stowing assembly.

2. The walking aid of claim 1, wherein a third bracket is mounted on the first frame main bar at the third connection position, and wherein a fourth bracket is mounted on the second frame main bar at the fourth connection position.

3. The walking aid of claim 2, wherein one end of the first support rod is connected to the first bracket, and the other end of the first support rod is connected to the fourth bracket at the fourth connection position, and wherein one end of the second support rod is connected to the second bracket, and the other end of the second support rod is connected to the third bracket at the third connection position.

4. The walking aid of claim 2, wherein the third bracket is fixedly arranged at a bottom end of the first frame main bar, and wherein the fourth bracket is fixedly arranged at a bottom end of the second frame main bar.

5. The walking aid of claim 2, wherein the third bracket is slidable vertically along the first frame main bar, and wherein the fourth bracket is slidable vertically along the second frame main bar.

6. The walking aid of claim 1, wherein the first bracket is slidable vertically along the first frame main bar, and wherein the second bracket is slidable vertically along the second frame main bar.

7. The walking aid of claim 1, wherein the first stowing assembly comprises a first front connecting rod, a first rear connecting rod, a first front rotating rod and a first rear rotating rod, and wherein the second stowing assembly comprises a second front connecting rod, a second rear connecting rod, a second front rotating rod and a second rear rotating rod.

8. The walking aid of claim 7, wherein the first front rotating rod and the first rear rotating rod are configured to lift the first set of front and rear wheels upward during folding, wherein the first set of front and rear wheels is flush with or higher than a bottom end of the first frame main bar after the folding, and wherein the second front rotating rod and the second rear rotating rod are configured to lift the second set of front and rear wheels upward during folding, wherein the second set of front and rear wheels is flush with or higher than a bottom end of the second frame main bar after the folding.

9. The walking aid of claim 7, wherein the first front connecting rod and the first front rotating rod are connected to a first front wheel of the first set of front and rear wheels, and wherein the second front connecting rod and the second front rotating rod are connected to a second front wheel of the second set of front and rear wheels.

10. The walking aid of claim 9, wherein the first front wheel is provided with a first steering mechanism, wherein the first steering mechanism includes a first connecting portion and a second connecting portion, wherein the first front connecting rod is connected to the first connecting portion, and wherein the first front rotating rod is connected to the second connecting portion.

11. The walking aid of claim 9, wherein the second front wheel is provided with a second steering mechanism, wherein the second steering mechanism includes a third connecting portion and a fourth connecting portion, wherein the second front connecting rod is connected to the third connecting portion, and wherein the second front rotating rod is connected to the fourth connecting portion.

12. The walking aid of claim 7, wherein the first rear connecting rod and the first rear rotating rod are connected to a first rear wheel of the first set of front and rear wheels, and wherein the second rear connecting rod and the second rear rotating rod are connected to a second rear wheel of the second set of front and rear wheels.

13. The walking aid of claim 1, wherein a first auxiliary rod is provided at the third connection position, and a second auxiliary rod is provided at the fourth connection position, wherein one end of the first support rod is connected to the first bracket, and the other end of the first support rod is connected to the fourth connection position through the second auxiliary rod, and wherein one end of the second support rod is connected to the second bracket, and the other end of the second support rod is connected to the third connection position through the first auxiliary rod.

14. The walking aid of claim 13, wherein the first frame main bar provides a first sliding groove and the second frame main bar provides a second sliding groove, and wherein the first auxiliary rod is configured to move within a range of the first sliding groove and the second auxiliary rod is configured to move within a range of the second sliding groove.

15. The walking aid of claim 1, wherein a height of the first frame main bar and a height of the second frame main bar are less than 56 cm.

16. The walking aid of claim 1, wherein a diameter of a first front wheel of the first set of front and rear wheels is smaller than a diameter of a first rear wheel of the first set of front and rear wheels, and wherein a diameter of a second front wheel of the second set of front and rear wheels is smaller than a diameter of a second rear wheel of the second set of front and rear wheels.

17. The walking aid of claim 1, wherein a diameter of a first front wheel of the first set of front and rear wheels is equal to a diameter of a first rear wheel of the first set of front and rear wheels, and wherein a diameter of a second front wheel of the second set of front and rear wheels is equal to a diameter of a second rear wheel of the second set of front and rear wheels.
